(19) United States
(12) Patent Application Publication
(10) Pub. No.: US 2007/0024788 A1
(43) Pub. Date: Feb. 1, 2007

(54) Liquid crystal display

(76) Inventors: Hiroyuki Kamiya, Bundang-gu (KR); Baek-Kyun Jeon, Yongin-si (KR); Soon-Joon Rho, Suwon-si (KR)

Correspondence Address: F. CHAU & ASSOCIATES, LLC, 130 WOODBURY ROAD, WOODBURY, NY, 11797, US

(21) Appl. No.: 11/473,365

(22) Filed: Jun. 22, 2006

(30) Foreign Application Priority Data
Jun. 22, 2005 (KR) 10-2005-0053885

(51) Int. Cl. G02F 1/1343

(52) U.S. Cl. 349/139

(57) ABSTRACT

A liquid crystal display is provided. The liquid crystal display includes a common electrode panel comprising a common electrode; a thin film transistor array panel facing the common electrode panel; and a liquid crystal layer disposed between the common electrode panel and the thin film transistor array panel, wherein the common electrode has a reflectivity of about 5% or less for incident light passing through the thin film transistor array panel.

### CROSS-REFERENCE TO RELATED APPLICATION

This application claims priority under 35 U.S.C. §119 to Korean Patent Application No. 2005-0053885, filed on Jun. 22, 2005, the disclosure of which is incorporated by reference herein in its entirety.

### BACKGROUND OF THE INVENTION

1. Technical Field

The present invention relates to a liquid crystal display.

2. Discussion of the Related Art

A liquid crystal display (LCD) has become one of the most widely used flat panel displays since its small size, thinness, and low power consumption make it suitable for use in many electronic devices. For example, the LCD is commonly found in a variety of electronic devices such as flat screen televisions, laptop computers, cell phones, and digital cameras.

Generally, an LCD includes a thin film transistor array panel including gate lines, data lines, thin film transistors, and pixel electrodes, a common electrode panel facing the thin film transistor array panel including color filters and a common electrode, and a liquid crystal layer sandwiched between the thin film transistor array panel and the common electrode panel.

In the LCD, images are displayed by applying voltages to the pixel and common electrodes to form an electric field therebetween. In response to the electric field, liquid crystal molecules in the liquid crystal layer are twisted to vary light transmittance of the liquid crystal layer. The electric field between the pixel and common electrodes is controlled by the pixel electrode, which uses the thin film transistor as a switching element. The thin film transistor transfers or blocks image signals transmitted through the data line in accordance with a scanning signal transmitted through the gate line.

When no voltages are applied to the pixel and common electrodes, the liquid crystal molecules in the liquid crystal layer are aligned in a predetermined direction due to alignment layers formed on the thin film transistor array panel and the color filter array panel. However, when the voltages are applied, the liquid crystal molecules are twisted in the direction of the electric field.

Since the liquid crystals are non-emissive elements, the LCD requires a light source such as a backlight. However, when light from the light source is incident upon a semiconductor of the thin film transistor, a current may leak thus causing flickers or other non-uniform images to be displayed on the LCD.

To prevent such non-uniform images from being displayed, the light from the light source is blocked by the gate line placed under the semiconductor so that it does not become incident upon the semiconductor. However, the light from the light source is reflected against the common electrode panel, and is incident upon the semiconductor, thereby causing a current to leak.

Accordingly, there is a need for an LCD that is capable of reducing current leakage due to the reflectivity of the common electrode panel.

### SUMMARY OF THE INVENTION

An embodiment of the present invention provides a liquid crystal display that prevents light from a light source from being reflected against an overlying layer and being incident upon the semiconductor of the thin film transistor.

An embodiment of the present invention provides a liquid crystal display that has a common electrode with an optimized thickness to reduce the amount of rays of light reflected against the common electrode and incident upon the semiconductor of the thin film transistor.

An embodiment of the present invention provides a liquid crystal display that includes a common electrode panel having a common electrode, a thin film transistor array panel facing the common electrode panel, and a liquid crystal layer disposed between the common electrode panel and the thin film transistor array panel. The common electrode has a reflectivity of about 5% or less for incident light passing through the thin film transistor array panel. The reflectivity may be about 2%.

The liquid crystal layer may be formed on a first side of the common electrode, and an overcoat may be formed on a second side of the common electrode.

A thickness of the common electrode may be determined by refractive indices of the liquid crystal layer, the common electrode, and the overcoat.

The common electrode panel may further have a black matrix, and the black matrix may be formed with an organic material.

A backlight may be placed behind the thin film transistor array panel, the backlight may have a light source.

According to another aspect of the present invention, a liquid crystal display includes a common electrode panel having a common electrode, a thin film transistor array panel facing the common electrode panel, and a liquid crystal layer disposed between the common electrode panel and the thin film transistor array panel. The common electrode has a reflectivity of about 5% or less for blue and green rays of incident light passing through the thin film transistor array panel.

The common electrode may have a refractive index of about 2.1, the overcoat may have a refractive index of about 1.6, and the liquid crystal layer may have a refractive index of about 1.5.

The liquid crystal layer may have a thickness of about 4.

The common electrode may have a thickness of about 1100 nm to about 1200 nm.

The common electrode may have a refractive index of about 2.1, the overcoat may have a refractive index of about 1.7, and the liquid crystal layer may have a refractive index of about 1.5.

The reflectivity may be about 2%.

The liquid crystal layer may be formed on a first side of the common electrode, and an overcoat may be formed on a second side of the common electrode.

The common electrode panel may further have a black matrix, and the black matrix may be formed with an organic material.

According to another aspect of the present invention, a liquid crystal display includes a common electrode panel having a common electrode, a thin film transistor array panel facing the common electrode panel, and a liquid crystal layer disposed between the common electrode panel and the thin film transistor array panel. The common electrode has a reflectivity of about 5% or less for blue rays of incident light passing through the thin film transistor array panel.

The liquid crystal layer may be formed on a first side of the common electrode, and an overcoat may be formed on a second side of the common electrode.

The common electrode panel may further have a black matrix, and the black matrix may be formed with an organic material.

The reflectivity may be about 2%, and the common electrode may have a thickness of about 950 nm to about 1150 nm.

### BRIEF DESCRIPTION OF THE DRAWINGS

The above and other features of the present invention will become more apparent by describing in detail exemplary embodiments thereof with reference to the accompanying drawings, in which:

FIG. 1 is a plan view of a liquid crystal display (LCD) according to an exemplary embodiment of the present invention;

FIGS. 2 and 3 are cross-sectional views of the LCD respectively taken along a line II-II′ and a line III-III′ of FIG. 1;

FIG. 4 illustrates a progression of light rays in an LCD according to an exemplary embodiment of the present invention;

FIG. 5 illustrates a route of light rays reflected against a common electrode and incident upon a semiconductor layer in an LCD according to an exemplary embodiment of the present invention;

FIG. 6 is a cross-sectional view of a liquid crystal layer, a common electrode, and an overcoat of an LCD according to an exemplary embodiment of the present invention;

FIG. 7 is a graph illustrating reflectivity variation curves of a common electrode as a function of light wavelength per thickness of the common electrode in an LCD according to an embodiment of the present invention;

FIG. 8 is a graph illustrating reflectivity variation curves of a common electrode as a function of light wavelength per thickness of the common electrode and a refractive index of an overcoat in an LCD according to an exemplary embodiment of the present invention;

FIG. 9 is a graph illustrating a spectrum of light from a backlight according to an exemplary embodiment of the present invention; and

FIG. 10 is a graph illustrating thickness versus reflectivity of a common electrode in an LCD according to an exemplary embodiment of the present invention.

### DETAILED DESCRIPTION OF EXEMPLARY EMBODIMENTS

The present invention will now be described more fully hereinafter with reference to the accompanying drawings, in which exemplary embodiments of the invention are shown. The present invention may, however, be embodied in many different forms and should not be construed as limited to the embodiments set forth herein.

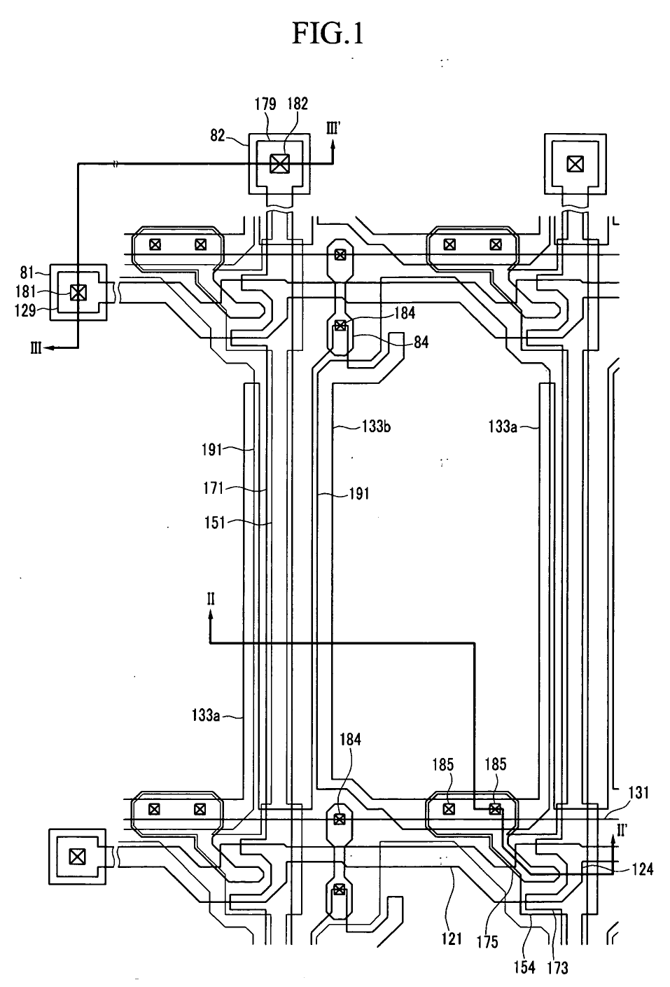

A liquid crystal display (LCD) according to an embodiment of the present invention will now be explained in detail with reference to FIGS. 1 to 3.

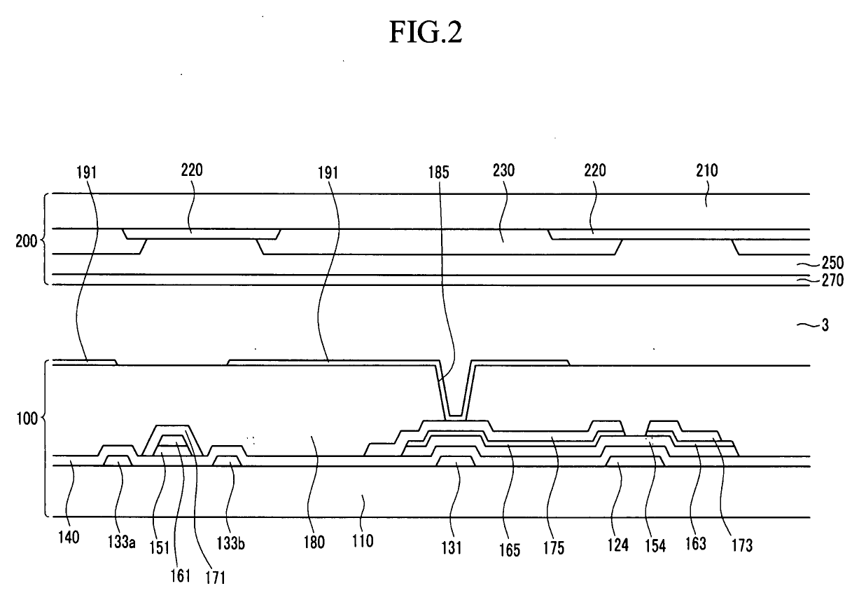

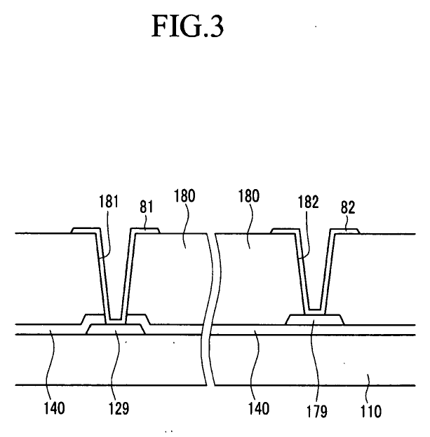

FIG. 1 is a plan view of an LCD according to an embodiment of the present invention, and FIGS. 2 and 3 are cross-sectional views of the LCD respectively taken along line II-II′ and line III-III′ of FIG. 1.

A thin film transistor array panel 100 of the LCD will now be explained with reference to FIGS. 1 to 3.

A plurality of gate lines 121 and a plurality of storage electrode lines 131 are formed on an insulating substrate 110 made of a material such as transparent glass or plastic.

The gate lines 121 extend in the horizontal direction to carry gate signals. Each of the gate lines 121 includes a plurality of gate electrodes 124 protruded downwards, and wide area end portions 129 for making a connection with other layers or external driving circuits. A gate driving circuit (not shown) may be mounted on a flexible printed circuit film (not shown) attached to the substrate 110, directly mounted on the substrate 110, or integrated with the substrate 110. When the gate driving circuit is integrated with the substrate 110, the gate lines 121 may be elongated and directly connected thereto.

The storage electrode lines 131 receive a predetermined voltage, and include trunk line portions proceeding substantially parallel to the gate lines 121, with pairs of storage electrodes 133a and 133b branched from the trunk line portions. Each storage electrode line 131 is disposed between two neighboring gate lines 121, and the trunk line portion thereof is located close to a bottom side of one of the two neighboring gate lines 121. Each of the storage electrodes 133a and 133b has a closed end connected to the relevant trunk line portion and a free end opposite thereto. The closed end of the storage electrode 133b has a wide area, and the free end thereof is diverged into a rectilinear portion and a bent portion. However, the shape and arrangement of the storage electrode lines 131 may be varied.

The gate lines 121 and the storage electrode lines 131 may be formed with an aluminum-based metallic material such as aluminum (Al) and an aluminum alloy, a silver-based metallic material such as silver (Ag) and a silver alloy, a copper-based metallic material such as copper (Cu) and a copper alloy, a molybdenum-based metallic material such as molybdenum (Mo) and a molybdenum alloy, chromium (Cr), nickel (Ni), tantalum (Ta), or titanium (Ti). Alternatively, the gate lines 121 and the storage electrode lines 131 may have a multi-layered structure with two conductive layers (not shown) differentiated by their physical properties. One of the conductive layers is formed with a metallic material having low resistivity to reduce signal delay or voltage drop, such as an aluminum-based metallic material, a silver-based metallic material, and a copper-based metallic material. By contrast, the other conductive layer is formed with a material having excellent physical, chemical, and electrical contact characteristics with respect to indium tin oxide (ITO) and indium zinc oxide (IZO), such as a molybdenum-based metallic material, titanium, and tantalum. Exemplary combinations of the multi-layered structure include a chromium-based under layer and an aluminum (alloy)-based over layer, and an aluminum (alloy)-based under layer and a molybdenum (alloy)-based over layer. Furthermore, the gate lines 121 and the storage electrode lines 131 may be formed with various other metals or conductors.

Lateral sides of the gate lines 121 and the storage electrode lines 131 are inclined against the substrate 110 with an inclination angle of about 30° to about 80°.

A gate insulating layer 140 is formed on the gate lines 121 and the storage electrode lines 131 with silicon nitride (SiNx) or silicon oxide (SiOx).

A plurality of linear semiconductors 151 are formed on the gate insulating layer 140 with hydrogenated amorphous silicon (a-Si) or polysilicon. The linear semiconductors 151 extend in the vertical direction, and have a plurality of projections 154 projected toward the gate electrodes 124. The linear semiconductors 151 have an enlarged width around the gate lines 121 and the storage electrode lines 131, and cover them.

A plurality of linear and island-shaped ohmic contacts 161 and 165 are formed on the semiconductors 151. The ohmic contacts 161 and 165 may be formed with n+hydrogenated amorphous silicon or silicide. The linear ohmic contact 161 has a plurality of projections 163. A pair of the projections 163 of the linear ohmic contact 161 and the island-shaped ohmic contact 165 are placed on the projection 154 of the semiconductor 151.

The lateral sides of the semiconductors 151 and the ohmic contacts 161 and 165 are inclined against the surface of the substrate 110 with an inclination angle of about 30° to about 80°.

A plurality of data lines 171 and a plurality of drain electrodes 175 are formed on the ohmic contacts 161 and 165 and the gate insulating layer 140.

The data lines 171 extend in the vertical direction to carry data signals, and cross the gate lines 121. The data lines 171 cross the storage electrode lines 131 and are placed between the neighboring storage electrodes 133a and 133b. Each of the data lines 171 includes a plurality of source electrodes 173 extended toward the gate electrodes 124, and wide area end portions 179 for making a connection with other layers or external driving circuits. A data driving circuit (not shown) may be mounted on a flexible printed circuit film (not shown) attached to the substrate 110 or directly mounted on the substrate 110, or may be integrated with the substrate 110. When the data driving circuit is integrated with the substrate 110, the data lines 171 may be elongated, and connected thereto.

The drain electrodes 175 are separated from the data lines 171, and face the source electrodes 173 around the gate electrodes 124. Each of the drain electrodes 175 has at one side a wide area end portion and at an opposite side a bar-shaped end portion. The wide area end portion is overlapped with the storage electrode line 131, and the bar-shaped end portion is partially surrounded by the source electrode 173.

One of the gate electrodes 124, one of the source electrodes 173, and one of the drain electrodes 175 form a thin film transistor TFT together with the projection 154 of the semiconductor 151, and the channel of the TFT is formed at the projection 154 between the source and the drain electrodes 173 and 175.

The data lines 171 and the drain electrodes 175 are preferably formed with refractory metals such as silver, copper, molybdenum, chromium, nickel, cobalt, tantalum, and titanium, or alloys thereof. Alternatively, the data lines 171 and the drain electrodes 175 may have a multi-layered structure with a refractory metal-based layer (not shown) and a low resistance conductive layer (not shown). Examples of the multi-layered structure include a double-layered structure of a chromium or molybdenum (alloy)-based under layer and an aluminum (alloy)-based over layer, and a triple-layered structure of a molybdenum (alloy)-based under layer, an aluminum (alloy)-based middle layer and a molybdenum (alloy)-based over layer. Furthermore, the data lines 171 and the drain electrodes 175 may be formed with various other metals or conductors.

The lateral sides of the data lines 171 and the drain electrodes 175 are preferably inclined against the surface of the substrate 110 with an inclination angle of about 30° to about 80°.

The ohmic contacts 161 and 165 exist only between the underlying semiconductor 151 and the overlying data line 171 and drain electrode 175 to lower the contact resistance therebetween. The width of the linear semiconductor 151 is smaller than that of the data line 171 in most areas thereof, but the portion of the linear semiconductor 151 meeting the gate line 121 is widened to smooth a surface profile thereof, thereby preventing the data line 171 from being cut. The semiconductor 151 has portions exposed through the source and the drain electrodes 173 and 175 and not covered by the data line 171 and the drain electrode 175.

A passivation layer 180 is formed on the data lines 171, the drain electrodes 175, and the exposed portions of the semiconductors 154. The passivation layer 180 is formed with an inorganic insulating material such as silicon nitride and silicon oxide, an organic insulating material, or a low dielectric insulating material. The dielectric constant of the organic insulating material and the low dielectric insulating material is preferably about 4.0 or less. Examples of the low dielectric insulating material are a-Si:C:O and a-Si:O:F formed through plasma enhanced chemical vapor deposition (PECVD). The passivation layer 180 may be formed with an organic insulating material having photosensitivity, and the surface of thereof may be flattened. Alternatively, the passivation layer 180 may have a double-layered structure including an inorganic under layer and an organic over layer such that it has an excellent insulating characteristic due to the organic layer, but does not harm the exposed portions of the semiconductors 151.

A plurality of contact holes 182 and 185 are formed at the passivation layer 180 to expose the end portions 179 of the data lines 171 and the drain electrodes 175. A plurality of contact holes 181 exposing the end portions 129 of the gate lines 121 as well as a plurality of contact holes 184 partially exposing the storage electrode lines 131 around the closed ends of the storage electrodes 133b are formed at the passivation layer 180 and the gate insulating layer 140.

A plurality of pixel electrodes 191, a plurality of overpasses 84 and a plurality of contact assistants 81 and 82 are formed on the passivation layer 180 with a transparent conductive material such as ITO and IZO, or a reflective metallic material such as aluminum, silver, and alloys thereof.

The pixel electrodes 191 are physico-electrically connected to the drain electrodes 175 through the contact holes 185 to receive data voltages from the drain electrodes 175. The pixel electrode 191 receiving the data voltage forms an electric field in association with a common electrode 270 of a common electrode panel 200 receiving the common voltage to orient liquid crystal molecules of a liquid crystal layer 3 between the two electrodes. The pixel electrode 191 and the common electrode 270 form a capacitor (hereinafter referred to as a liquid crystal capacitor) to store the applied voltage even after the thin film transistor turns off.

The pixel electrode 191 is overlapped with the storage electrode line 131 by the storage electrodes 133a and 133b. The pixel electrode 191 and the drain electrode 175 electrically connected thereto are overlapped with the storage electrode line 131 to form a storage capacitor, which reinforces the voltage storage capacity of the liquid crystal capacitor.

The contact assistants 81 and 82 are connected to the end portions 129 of the gate lines 121 and the end portions 179 of the data lines 171 through the respective contact holes 181 and 182. The contact assistants 81 and 82 reinforce the adhesion of the end portions 179 and 129 of the data and the gate lines 171 and 121 to external devices, and protect them.

The overpass 84 crosses the gate line 121, and is connected to the exposed portion of the storage electrode line 131 and the exposed free end portion of the storage electrode 133b through the contact holes 184 placed around the gate line 121 opposite to each other. The storage electrode line 131 with the storage electrodes 133a and 133b may be used to repair flaws in the gate line 121, the data line 171, or the thin film transistor by using the overpass 84.

The common electrode panel 200 will be now explained with reference to FIGS. 2 and 3.

A light blocking member 220 is formed on an insulating substrate 210 made of a material such as transparent glass or plastic. The light blocking member 220 has a linear portion (not shown) corresponding to the data line 171, and a planar portion (not shown) corresponding to the thin film transistor. The light blocking member 220 blocks the leakage of light.

A plurality of color filters 230 are formed on the substrate 210. The color filters 230 are placed within an area surrounded by the light blocking member 220. The color filters 230 may be vertically elongated along the columns of the pixel electrodes 191. The color filters 230 may each express one of the primary colors of red, green, and blue.

An overcoat 250 is formed on the color filters 230 and the light blocking member 220. The overcoat 250 may be formed with an organic insulating material. The overcoat 250 prevents the color filters 230 from being exposed, and provides a flattened surface.

A common electrode 270 is formed on the overcoat 250. The common electrode 270 is formed with a transparent conductor such as ITO and IZO. The common electrode 270 has a thickness that is large enough for the incident light transmitted through the underlying liquid crystal layer 3 to have a reflectivity of about 5% or less, preferably about 2% or less. The thickness of the common electrode 270 may differentiate depending upon the overlying and underlying layer structures and formation materials around the common electrode 270.

An alignment layer (not shown) is formed on the inner surfaces of the panels 100 and 200, respectively. The alignment layer may be a vertical alignment layer or a horizontal alignment layer. A polarizer (not shown) is provided on the outer surfaces of the panels 100 and 200, respectively. The polarizing axes of the two polarizers proceed perpendicular to each other, and one of the polarizing axes preferably proceeds parallel to the gate lines 121.

The LCD according to the present embodiment may further include a retardation film (not shown) for compensating for the retardation of the liquid crystal layer 3, and a backlight unit (not shown) for supplying light to the polarizer, the retardation film, the panels 100 and 200, and the liquid crystal layer 3.

The liquid crystal layer 3 has dielectric anisotropy. The liquid crystal molecules of the liquid crystal layer 3 may employ a vertical alignment (VA) mode where the long axis thereof proceeds vertical to the surfaces of the panels 100 and 200 with no application of an electric field, or a twisted nematic (TN) mode where the long axis thereof proceeds parallel to the surfaces of the panels 100 and 200.

When a common voltage is applied to the common electrode 270 and a data voltage is applied to the pixel electrode 191, an electric field is formed between the panels 100 and 200. The liquid crystal molecules are realigned in response to the electric field.

The common electrode 270 and the reflectivity thereof will now be explained in detail.

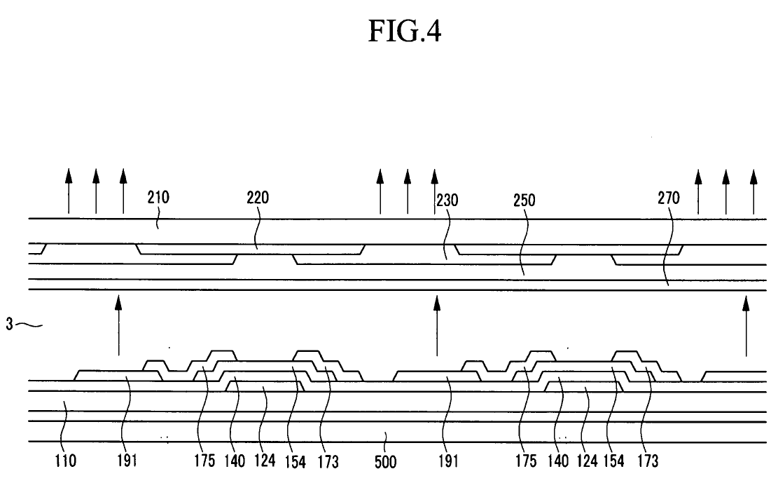

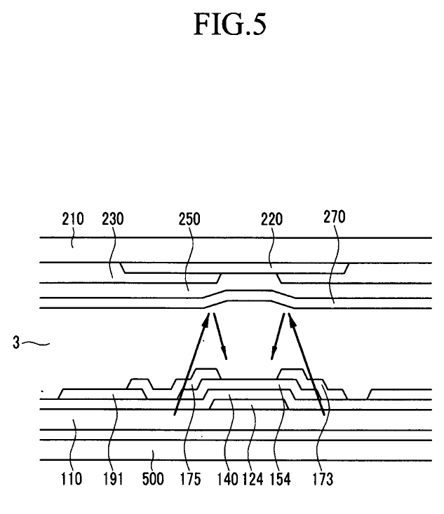

FIG. 4 illustrates a progression of light rays in an LCD according to an embodiment of the present invention, and FIG. 5 illustrates a route of light rays reflected against a common electrode and incident upon a semiconductor layer in an LCD according to an embodiment of the present invention.

FIGS. 4 and 5 show a cross-sectional view of the LCD, the LCD including a backlight 500.

Light from a light source (not shown) of the bottom backlight 500 progresses to the top of the LCD through a portion of the pixel electrode 191, and passes the overlying liquid crystal layer 3, the common electrode 270, the overcoat 250, the color filter 230, and the polarizer (not shown), followed by being emitted to the outside.

The luminance of the LCD is commonly about 500 cd/. However, light is partially dissipated through the polarizers and the color filters 230. The light is commonly dissipated through the polarizers by about 50%, and through the color filters 230 by about 30%. Considering the light dissipation, the luminance of the liquid crystal layer 3 is about 3000 cd/. or more. As shown in FIG. 5, light with a high luminance is partially reflected while passing through the common electrode 270, and the reflected light is incident upon the semiconductor layer, thereby causing the light to leak.

To reduce the amount of light reflected by the common electrode 270 to be about 5% or less (preferably about 2% or less), suitable refractive indices of the overcoat 250, the common electrode 270, and the liquid crystal layer 3 are used.

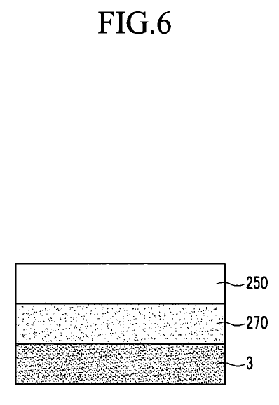

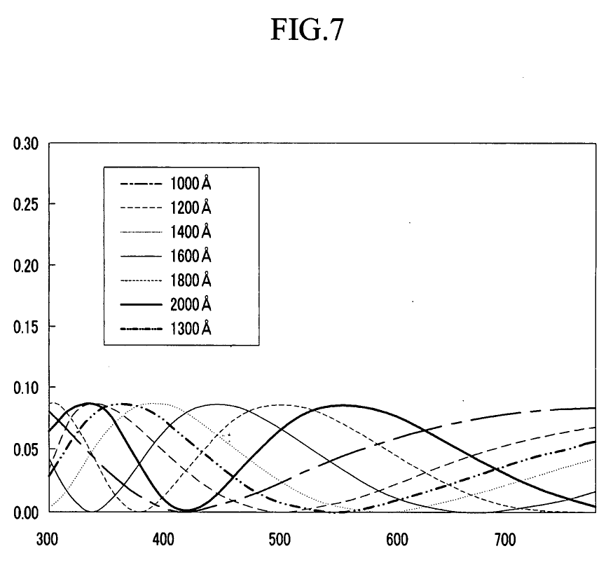

FIG. 6 is a cross-sectional view of an LCD according to an embodiment of the present invention schematically illustrating a liquid crystal layer 3, a common electrode 270, and an overcoat 250. FIG. 7 is a graph illustrating reflectivity variation curves as a function of light wavelength per thickness of the common electrode 270.

Here, the refractive index of the liquid crystal layer 3 is about 1.5, the refractive index of the common electrode 270 is about 2.1, and the refractive index of the overcoat 250 is about 1.6. The common electrode 270 is formed with ITO. The thickness of the liquid crystal layer 3, which is irrelevant to the reflectivity, is about 4. Furthermore, the x axis of the graph of FIG. 7 indicates the wavelength with a unit of nm, and the y axis thereof indicates the reflectivity.

As shown in FIG. 7, the light wavelength where the reflectivity is minimized is differentiated depending upon the thickness of the common electrode 270. Furthermore, the longer the wavelength, the lesser the variation in reflectivity, and the shorter the wavelength, the more radical the variation in reflectivity.

In FIG. 7 the light reflectance of blue and green rays having a short wavelength is sensitively varied with respect to the thickness of the common electrode 270. However, the light reflectance of the red ray is varied less sensitively. Accordingly, the blue and green rays, rather than the red ray, should be considered when determining the thickness of the common electrode 270 to reduce the reflectivity thereof.

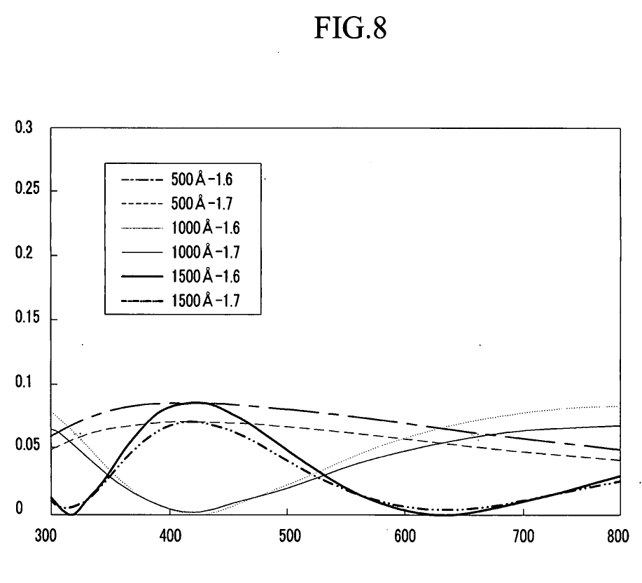

FIG. 8 illustrates reflectivity variation curves of the common electrode 270 as function of light wavelength per thickness of the common electrode 270 and a refractive index of an overcoat 250 in an LCD according to an embodiment of the present invention.

As shown in FIG. 8, the reflectivity was measured by varying the refractive index of the overcoat 250 to be about 1.6 or about 1.7 as well as by varying the thickness of the common electrode 270. The x axis of the graph of FIG. 8 indicates the wavelength with a unit of nm, and the y axis thereof indicates the reflectivity.

As shown in FIG. 8, even though the refractive indices of the overcoat 250 are varied, the wavelengths are not influenced. For example, the wavelength with a minimum reflectivity and the wavelength with a maximum reflectivity are not varied, but the maximum value of the reflectivity is slightly altered.

As shown in FIG. 8, when the refractive index of the overcoat 250 of about 1.6 is compared with the refractive index of about 1.7, the former has a higher reflectivity. Therefore, the overcoat 250 is preferably formed with a material having a refractive index of about 1.7 rather than a material having a refractive index of about 1.6, or preferably with a material having a refractive index of more than about 1.7.

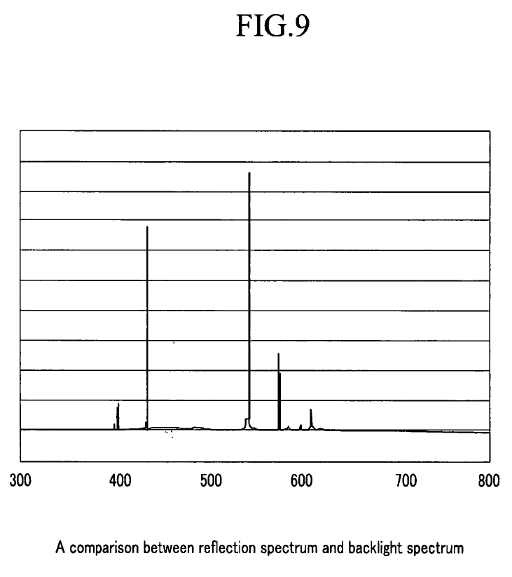

FIG. 9 is a graph illustrating a spectrum of light from a backlight 500 according to an embodiment of the present invention.

As shown in FIG. 9, the backlight 500 contains a large number of light rays with predetermined wavelengths, such as blue rays with wavelengths of 440 nm and green rays with wavelengths of 550 nm. The number of red rays in the backlight 500 is smaller in number than that of the other rays.

Since the light from the backlight 500 mainly has rays with predetermined wavelengths, the predetermined wavelengths should be used to determine the thickness of the common electrode 270 to reduce the reflectivity.

Further, in FIG. 7, as the blue and the green rays are sensitively varied due to the thickness of the common electrode 270 and because the backlight contains more blue and green rays, the optimized thickness of the common electrode 270 should also be determined based on the blue and the green rays.

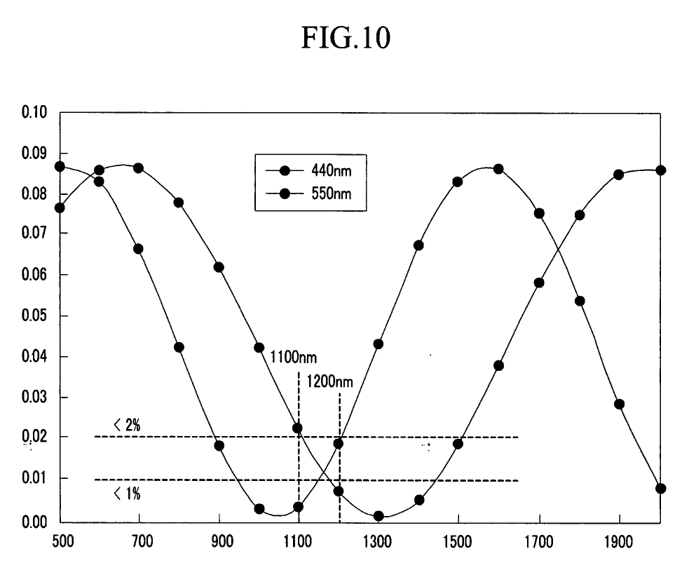

FIG. 10 is a graph illustrating reflectivity versus thickness of a common electrode in an LCD according to an embodiment of the present invention.

FIG. 10 illustrates a variation in the reflectivity of the blue rays (e.g., 440 nm) and the green rays (e.g., 550 nm) as a function of a thickness of the common electrode 270. The x axis of the graph of FIG. 10 indicates the thickness of the common electrode 270 with a unit of ., and the y axis thereof indicates the reflectivity.

As shown in FIG. 10, the thickness of the common electrode 270 should be about 1100 nm to about 1200 nm, the thickness being enough to obtain a reflectivity of about 2% or less with respect to the blue and the green rays.

However, the blue rays exhibit a more radical variation in reflectivity as compared to the green rays. Therefore, when reflectivity is based on the blue rays, the thickness of the common electrode is preferably about 950 nm to about 1150 nm.

In this way, when the thickness of the common electrode 270 is optimized, its reflectivity is lowered, and as a result, the light reflected against the common electrode 270 and incident upon the semiconductor layer is reduced, thereby decreasing the leakage of current and enhancing the display characteristics of an LCD.

According to an embodiment of the present invention, it is preferable that the refractive index of the overcoat 250 be controlled to reduce the reflectivity after the thickness of the common electrode 270 is optimized. Furthermore, to reduce the light reflected against the black matrix 220 and incident upon the semiconductor, the black matrix 220 is preferably formed with an organic material, not with a metallic material such as chromium Cr.

In addition, even though only the refractive indices of the overcoat 250, the common electrode 270, and the liquid crystal layer 3 have been used to determine reflectivity, an alignment layer disposed between the liquid crystal layer 3 and the common electrode 270 may be also used. Further, it is preferable that additional structures around the common electrode 270 and the liquid crystal layer 3 be used to determine reflectivity.

According to an embodiment of the present invention, an LCD is provided wherein a thickness of a common electrode is optimized to reduce light that is reflected against the common electrode and that is incident upon a semiconductor of a thin film transistor. The thickness of the common electrode is optimally controlled such that light rays reflected by the common electrode and incident upon the semiconductor are reduced, thereby decreasing the leakage of current and preventing flickers or other non-uniform images from being displayed on the LCD.

While the present invention has been described in detail with reference to the exemplary embodiments, those skilled in the art will appreciate that various modifications and substitutions can be made thereto without departing from the spirit and scope of the present invention as set forth in the appended claims.

What is claimed is:

1. A liquid crystal display comprising:
a common electrode panel comprising a common electrode;
a thin film transistor array panel facing the common electrode panel; and
a liquid crystal layer disposed between the common electrode panel and the thin film transistor array panel,
wherein the common electrode has a reflectivity of about 5% or less for incident light passing through the thin film transistor array panel.

2. The liquid crystal display of claim 1, wherein the reflectivity is about 2%.

3. The liquid crystal display of claim 1, wherein the liquid crystal layer is formed on a first side of the common electrode, and an overcoat is formed on a second side of the common electrode.

4. The liquid crystal display of claim 3, wherein a thickness of the common electrode is determined by refractive indices of the liquid crystal layer, the common electrode, and the overcoat.

5. The liquid crystal display of claim 1, wherein the common electrode panel further comprises a black matrix formed with an organic material.

6. The liquid crystal display of claim 1, further comprising a backlight placed behind the thin film transistor array panel, the backlight including a light source.

7. A liquid crystal display comprising:
a common electrode panel comprising a common electrode;
a thin film transistor array panel facing the common electrode panel; and
a liquid crystal layer disposed between the common electrode panel and the thin film transistor array panel,
wherein the common electrode has a reflectivity of about 5% or less for blue and green rays of incident light passing through the thin film transistor array panel.

8. The liquid crystal display of claim 7, wherein the liquid crystal layer is formed on a first side of the common electrode, and an overcoat is formed on a second side of the common electrode.

9. The liquid crystal display of claim 8, wherein the common electrode has a refractive index of about 2.1, the overcoat has a refractive index of about 1.6, and the liquid crystal layer has a refractive index of about 1.5.

10. The liquid crystal display of claim 9, wherein the liquid crystal layer has a thickness of about 4.

11. The liquid crystal display of claim 9, wherein a thickness of the common electrode is about 1100 nm to about 1200 nm.

12. The liquid crystal display of claim 8, wherein the common electrode has a refractive index of about 2.1, the overcoat has a refractive index of about 1.7, and the liquid crystal layer has a refractive index of about 1.5.

13. The liquid crystal display of claim 7, wherein the reflectivity is about 2%.

14. The liquid crystal display of claim 7, wherein the common electrode panel further comprises a black matrix formed with an organic material.

15. A liquid crystal display comprising:
a common electrode panel comprising a common electrode;
a thin film transistor array panel facing the common electrode panel; and
a liquid crystal layer disposed between the common electrode panel and the thin film transistor array panel,
wherein the common electrode has a reflectivity of about 5% or less for blue rays of incident light passing through the thin film transistor array panel.

16. The liquid crystal display of claim 15, wherein the liquid crystal layer is formed on a first side of the common electrode, and an overcoat is formed on a second side of the common electrode.

17. The liquid crystal display of claim 15, wherein the common electrode panel further comprises a black matrix formed with an organic material.

18. The liquid crystal display of claim 15, wherein the reflectivity is about 2%.

19. The liquid crystal display of claim 18, wherein the common electrode has a thickness of about 950 nm to about 1150 nm.
